(19) United States
(12) Patent Application Publication
(10) Pub. No.: US 2009/0110992 A1
(43) Pub. Date: Apr. 30, 2009

(54) SOFC electrode sintering by microwave heating

(75) Inventor: Dien Nguyen, San Jose, CA (US)

Correspondence Address: FOLEY AND LARDNER LLP;SUITE 500, 3000 K STREET NW, WASHINGTON, DC, 20007, US

(73) Assignee: Bloom Energy Corporation

(21) Appl. No.: 12/289,510

(22) Filed: Oct. 29, 2008

Related U.S. Application Data
(60) Provisional application No. 61/000,891, filed on Oct. 30, 2007.

(51) Int. Cl. H01M 4/00; C08F 2/46; C08J 7/04

(52) U.S. Cl. 429/30; 427/508; 427/511; 427/521

(57) ABSTRACT

A method for debinding and sintering a solid oxide fuel cell (SOFC) electrode includes depositing a first paste comprising a binder material and a first electrode precursor material onto a first side of a ceramic SOFC electrolyte; and irradiating the first paste with microwave radiation to sinter and debind the first electrode.

### CROSS-REFERENCE TO RELATED PATENT APPLICATIONS

The present application claims benefit of U.S. provisional application 61/000,891, filed Oct. 30, 2007, which is incorporated herein by reference in its entirety.

### BACKGROUND OF THE INVENTION

The present invention is generally directed to fuel cell components, and to solid oxide fuel cell anode materials in particular.

Fuel cells are electrochemical devices which can convert energy stored in fuels to electrical energy with high efficiencies. Electrolyzer cells are electrochemical devices which can use electrical energy to reduce a given material, such as water, to generate a fuel, such as hydrogen. The fuel and electrolyzer cells may comprise reversible cells which operate in both fuel cell and electrolysis mode.

In a high temperature fuel cell system, such as a solid oxide fuel cell (SOFC) system, an oxidizing flow is passed through the cathode side of the fuel cell while a fuel flow is passed through the anode side of the fuel cell. The oxidizing flow is typically air, while the fuel flow can be a hydrocarbon fuel, such as methane, natural gas, pentane, ethanol, or methanol. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit. A solid oxide reversible fuel cell (SORFC) system generates electrical energy and reactant product (i.e., oxidized fuel) from fuel and oxidizer in a fuel cell or discharge mode and generates the fuel and oxidant using electrical energy in an electrolysis or charge mode.

SOFC electrode sintering requires long heat-up and cool-down profiles because of the thermal mass of the combination of kiln, furnace and furnace insulation bricks. The resulting long conditioning cycle results in driving up the cost of stack manufacturing of SOFCs. Additionally, the long sintering cycle induces grain growth in the base zirconia electrolyte. Such grain growth reduces the flexural strength of the electrolyte incorporated into SOFCs.

### SUMMARY OF THE INVENTION

One aspect of the present invention provides method of debinding and sintering a solid oxide fuel cell (SOFC) electrode, comprising depositing a first paste comprising a binder material and a first electrode precursor material onto a first side of a ceramic SOFC electrolyte, and irradiating the first paste with microwave radiation to sinter and debind the first electrode.

### BRIEF DESCRIPTION OF THE DRAWINGS

FIG. 1 illustrates a side cross-sectional view of SOFCs of the embodiments of the invention.

FIG. 2 illustrates a side cross sectional view of a SOFC stack of an embodiment of the invention.

### DETAILED DESCRIPTION OF THE EMBODIMENTS

Microwave energy is utilized as a heating source for debinding and sintering of SOFC cells. The frequency between about 0.3 GHz and about 300 GHz of the microwave energy may be adjusted for maximum absorption by a binder material of the electrode(s), such as a binder material used in electrode pastes deposited by screen printing, ink jet printing or similar methods. Furthermore, the microwave energy is readily absorbed by dielectric and ionic ceramics used in SOFCs, such as nickel oxide, perovskite(s) and zirconia.

The anode electrode of one embodiment of the invention comprises a cermet comprising a nickel containing phase and a ceramic phase. The nickel containing phase preferably consists entirely of nickel in a reduced state. This phase forms nickel oxide when it is in an oxidized state. Thus, the anode electrode is preferably annealed in a reducing atmosphere prior to operation to reduce the nickel oxide to nickel. The nickel containing phase may include other metals in additional to nickel and/or nickel alloys. The nickel is preferably finely distributed in the ceramic phase, with an average grain size less than 500 nanometers, such as 200 to 400 nanometers, to reduce the stresses induced when nickel converts to nickel oxide. The ceramic phase preferably comprises a stabilized zirconia, such as a scandia or yttria stabilized zirconia, and/or a doped ceria, such as a samaria, gadolinia or yttria doped ceria (in other words, the ceria may contain Sm, Gd and/or Y dopant element which forms an oxide upon incorporation into the ceria). Preferably, the doped ceria phase composition comprises Ce₍₁₋ₓ₎AₓO₂, where A comprises at least one of Sm, Gd, or Y, and x is greater than 0.1 but less than 0.4. For example, x may range from 0.15 to 0.3 and may be equal to 0.2. Samaria doped ceria (SDC) is preferred. Furthermore, the doped ceria may be non-stoichiometric, and contain more than or less than two oxygen atoms for each one metal atom. Alternatively, the ceramic phase comprises a different mixed ionic and electrically conductive phase, such as a perovskite ceramic phase, such as (La, Sr)(Mn,Cr)O₃, which includes LSM, lanthanum strontium chromite, (LaₓSr₁₋ₓ)(Mn_{y}Cr_{1-y})O₃ where 0.6<x<0.9, 0.1<y<0.4, such as x=0.8, y=0.2, etc.

In one non-limiting embodiment of the invention, the anode electrode contains less nickel phase in a portion near the electrolyte than in a portion near the electrode surface distal from the electrode (i.e., the “free” electrode surface which faces away from the electrolyte) as described in U.S. Provisional Patent Application Ser. No. 60/852,396 filed on Oct. 18, 2006, which is incorporated by reference in its entirety. In another embodiment of the invention, the anode electrode contains less porosity in a portion near the electrolyte than in a portion near the “free” electrode surface distal from the electrode. Preferably, the anode electrode contains less nickel and less porosity in the portion near the electrolyte.

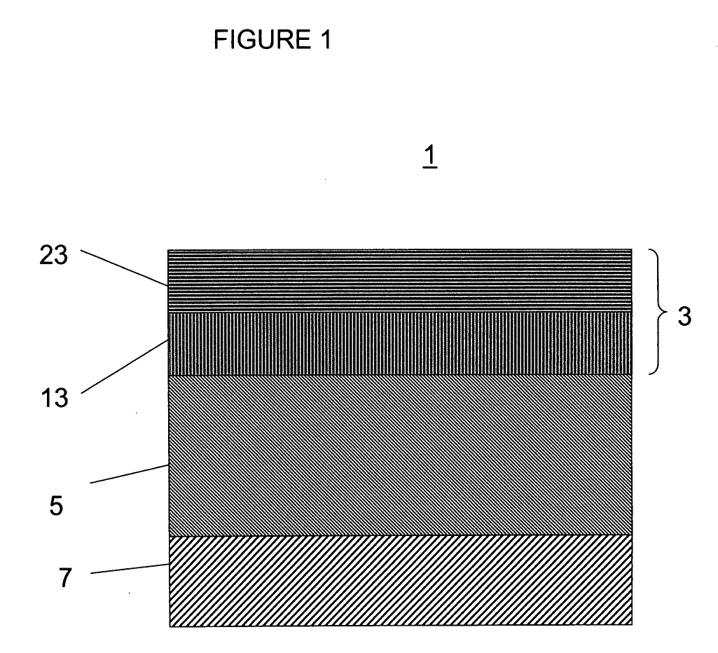

FIG. 1 illustrates a solid oxide fuel cell (SOFC) 1 according to an embodiment of the invention. The cell 1 includes an anode electrode 3, a solid oxide electrolyte 5 and a cathode electrode 7. The electrolyte 5 may comprise a stabilized zirconia, such as scandia stabilized zirconia (SSZ) or yttria stabilized zirconia (YSZ). Alternatively, the electrolyte 5 may comprise another ionically conductive material, such as a doped ceria. The cathode electrode 7 may comprise an electrically conductive material, such as an electrically conductive perovskite material, such as lanthanum strontium manganite (LSM). Other conductive perovskites, such as LSCo, etc., or metals, such as Pt, may also be used.

As shown in FIG. 1, the anode electrode 3 comprises a first portion 13 and a second potion 23. The first portion 13 is located between the electrolyte 5 and the second portion 23. As noted above, preferably, the first portion of the anode electrode 13 contains a lower ratio of the nickel containing phase to the ceramic phase than the second portion 23 of the anode electrode. Furthermore, preferably, the first portion of the anode electrode 13 contains a lower porosity than the second portion 23 of the anode electrode. Thus, the porosity and the ratio of the nickel phase to the ceramic phase increases in as a function of thickness of the anode electrode 3 in a direction from the electrolyte 5 to the opposite surface of the anode electrode 3.

For example, the first portion 13 of the anode electrode may contain a porosity of 5-30 volume percent and a nickel phase content of 1 to 20 volume percent. The second portion 23 of the anode electrode may contain a porosity of 31 to 60 volume percent and a nickel phase content of 21 to 60 volume percent.

In one embodiment, the first 13 and the second 23 portions of the anode electrode 3 comprise separate sublayers. Thus, the first region 13 comprises a first sublayer in contact with the electrolyte 5 and the second region 23 comprises a second sublayer located over the first sublayer 13. The first sublayer 13 contains a lower porosity and lower nickel to doped ceria ratio than the second sublayer 23.

The first sublayer 13 may contain between 1 and 15 volume percent of the nickel containing phase, between 5 and 30 percent pores, such as between 5 and 20 or between 15 and 25 volume percent pores, and remainder the doped ceria phase, for example between 1 and 5 volume percent of the nickel containing phase, between 5 and 10 volume percent pores and remainder the doped ceria phase. The second sublayer 23 contains over 20 volume percent nickel containing phase, between 20 and 60 volume percent pores, such as between 40 and 50 percent pores, and remainder the doped ceria phase, such as between 30 and 50 volume percent of the nickel containing phase, between 30 and 50 volume percent pores and remainder the doped ceria phase. In the first sublayer 13, the volume ratio of the nickel containing phase to the doped ceria containing phase may range from 1:8 to 1:10, for example 1:9. In the second sublayer 23, the volume ratio of the nickel containing phase to the doped ceria containing phase may range from 3:1 to 5:1, for example 4:1. The first sublayer 13 may contain between 5 and 25 weight percent nickel containing phase, such as between 10 and 20 weight percent nickel containing phase, and between 75 and 95 weight percent doped ceria containing phase, such as between 80 and 90 weight percent doped ceria phase. The second sublayer 23 may contain between 60 and 85 weight percent nickel containing phase, such as between 70 and 75 weight percent nickel containing phase, and between 15 and 40 weight percent doped ceria containing phase, such as between 25 and 30 weight percent doped ceria phase. Optionally, sublayers 13 and/or 23 may contain other materials or phases besides the nickel containing phase and the doped ceria containing phase.

Thus, the anode electrode 3 contains plurality of sublayers, each varying in composition, structure and nickel content. Each layer is approximately 3-30 microns thick, such as 5-10 microns thick, for example. The first layer in contact with the electrolyte has a higher density and lower nickel content than the one or more layers further away from the electrolyte. A porosity gradient is established ranging from approximately 5-15% close to the electrolyte and increasing to about 50% at the anode electrode's free surface. The nickel content in the electrode increases in a similar manner as the porosity.

In another embodiment of the invention, each of the first 13 and second 23 regions may comprise plural sublayers. For example, each region 13, 23 may contain two sublayers, such that the anode electrode 3 contains a total of four sublayers. In this case, the first region 13 comprises a first sublayer in contact with the electrolyte and a second sublayer located over the first sublayer, while the second region 23 comprises a third sublayer located over the second sublayer and a fourth sublayer located over the third sublayer. In this configuration, a porosity of the anode electrode increases from the first sublayer to the fourth sublayer and the nickel phase content of the anode electrode increases from the first sublayer to the fourth sublayer. In other words, the sublayer which contacts the electrolyte 5 has the lowest porosity and nickel phase content, while the sublayer which is located farthest from the electrolyte contains the highest porosity and nickel phase content (and the lowest doped ceria phase content).

For example, the first sublayer closest to the electrolyte 5 may contain between 1 and 5 volume percent of the nickel containing phase, between 5 and 15 volume percent pores and remainder the doped ceria phase. The second sublayer may contain between 6 and 20 volume percent of the nickel containing phase, between 20 and 40 volume percent pores and remainder the doped ceria phase. The third sublayer may contain between 25 and 35 volume percent of the nickel containing phase, between 30 and 50 volume percent pores and remainder the doped ceria phase. The fourth sublayer which is farthest from the electrolyte 5 may contain between 35 and 45 volume percent of the nickel containing phase, between 40 and 60 volume percent pores and remainder the doped ceria phase.

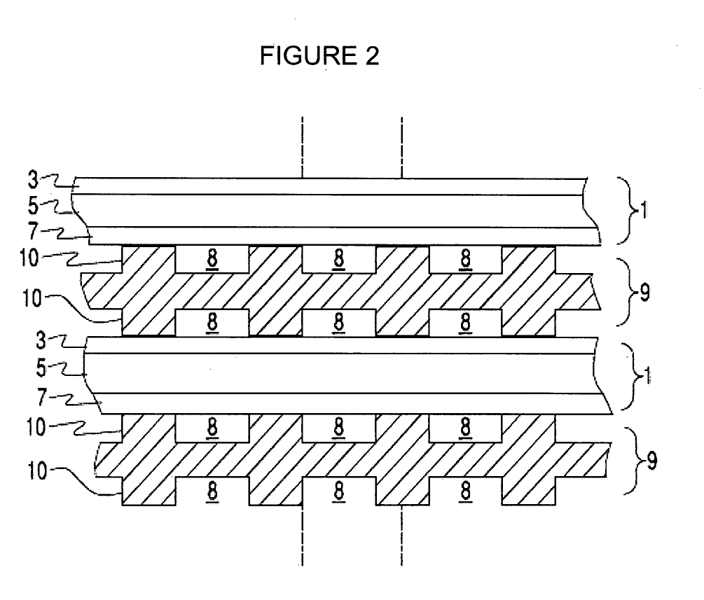

Fuel cell stacks are frequently built from a multiplicity of SOFC's 1 in the form of planar elements, tubes, or other geometries. Fuel and air has to be provided to the electrochemically active surface, which can be large. As shown in FIG. 2, one component of a fuel cell stack is the so called gas flow separator (referred to as a gas flow separator plate in a planar stack) 9 that separates the individual cells in the stack. The gas flow separator plate separates fuel, such as a hydrocarbon fuel, flowing to the fuel electrode (i.e. anode 3) of one cell in the stack from oxidant, such as air, flowing to the air electrode (i.e. cathode 7) of an adjacent cell in the stack. The separator 9 contains gas flow passages or channels 8 between the ribs 10. Frequently, the gas flow separator plate 9 is also used as an interconnect which electrically connects the fuel electrode 3 of one cell to the air electrode 7 of the adjacent cell. In this case, the gas flow separator plate which functions as an interconnect is made of or contains electrically conductive material. An electrically conductive contact layer, such as a nickel contact layer, may be provided between the anode electrode and the interconnect. FIG. 2 shows that the lower SOFC 1 is located between two gas separator plates 9.

Furthermore, while FIG. 2 shows that the stack comprises a plurality of planar or plate shaped fuel cells, the fuel cells may have other configurations, such as tubular. Still further, while vertically oriented stacks are shown in FIG. 2, the fuel cells may be stacked horizontally or in any other suitable direction between vertical and horizontal.

The term “fuel cell stack,” as used herein, means a plurality of stacked fuel cells which share a common fuel inlet and exhaust passages or risers. The “fuel cell stack,” as used herein, includes a distinct electrical entity which contains two end plates which are connected to power conditioning equipment and the power (i.e., electricity) output of the stack. Thus, in some configurations, the electrical power output from such a distinct electrical entity may be separately controlled from other stacks. The term “fuel cell stack” as used herein, also includes a part of the distinct electrical entity. For example, the stacks may share the same end plates. In this case, the stacks jointly comprise a distinct electrical entity. In this case, the electrical power output from both stacks cannot be separately controlled.

A method of debinding and sintering SOFC 1 shown in FIG. 1 includes mixing a binder material and an electrode precursor material (such as nickel oxide and a ceramic, such as a doped ceria and/or a stabilized zirconia) into a paste. The paste is further deposited onto a ceramic SOFC electrolyte. The paste is then irradiated with microwave energy to sinter and debind the electrode. The electrode may be locally heated and decomposed while the support structure of the furnace remains at a relatively low temperature. This direct heating uses much less energy and processing time than other sinter methods. Such optimized binder burn-out and glass melting process is fast and energy efficient with minimal thermal gradient stress on the entire stack.

The method may include forming the cathode electrode 7 on a first side of a planar solid oxide electrolyte 5 and forming the cermet anode electrode 3 on a second side of the planar solid oxide electrode. If desired, a first portion of the anode electrode adjacent to the electrolyte contains a lower porosity and a lower ratio of the nickel containing phase to the ceramic phase than the second portion of the anode electrode located distal from the electrolyte. The anode and the cathode may be formed in any order on the opposite sides of the electrolyte. The same or different frequency of the microwave energy may be used for heating and melting the inorganic active materials such as NiO, zirconia and LSM or other perovskites. A different frequency may be used if it has better absorption in the specific material class. For example, a first frequency microwave radiation may be used to sinter the anode electrode and a different, second frequency microwave radiation may be used to sinter the cathode electrode before or after sintering the anode electrode. The first frequency is selected for maximum microwave absorption by the anode electrode precursor paste and the second frequency is selected for maximum microwave absorption by the cathode electrode precursor paste. The first frequency microwave radiation and the second frequency microwave radiation may be provided at the same time or sequentially.

Multiple microwave sources and/or one or more multi-mode microwave sources which emit different microwave frequencies at the same time can be positioned in the sintering furnace to facilitate co-sintering of both the anode and cathode. Thus, plural frequencies of microwave radiation, such as two different frequencies, may be used at the same time to co-sinter the anode and cathode electrode. Once the sintering process is complete, cooling can be accomplished by simply turning off the microwave source.

Because electrode sintering time is reduced, large-scale stack production is feasible. For example, a custom continuous microwave electrode sintering furnace can be developed and its throughput can be matched with a robotic stack assembly. With the faster heating and cooling available with microwave sintering, the microstructure of both electrodes and the base zirconia electrolyte would be finer than those resulting from other sintering methods. The strength of a completed SOFC would approximate that of the blank electrolyte. Thus, the microwave method provides a lower cost, energy and time efficient method for electrode sintering. The method provides a practical continuous stack sintering approach that enables large scale cell production. The microstructure of both electrodes and the base zirconia electrolyte subjected to microwave sintering would be finer than that resulting from thermal sintering because both heating and cooling occur fast.

In one embodiment, the anode electrode may be formed with a plurality of sublayers shown in FIG. 1. A first sublayer 13 containing a low porosity and a low nickel content can be screen printed on the electrolyte 5, followed by screen printing a second sublayer 23 with a higher porosity and a higher nickel content on the first sublayer 13.

If desired, during the deposition, the nickel content and porosity may be varied in different regions of the anode electrode to form an anode electrode with a graded composition. The graded composition may comprise a uniformly or a non-uniformly graded composition in a thickness direction of the anode electrode. In this case, the ratio of the nickel to doped ceria precursor material is increased as the thickness of the deposited layer increases. Furthermore, the anode composition can be graded uniformly or non-uniformly in a direction from a fuel inlet to a fuel outlet, such as by using plural nozzles which provide a different nickel/doped ceria ratio precursor materials to different regions of the anode electrode.

A typical example of a multi-sublayer anode electrode is provided in Table 1 where four sublayers are described.

TABLE 1

| | Volme | | | |
|---|---|---|---|---|
| | fraction | Volume | Volume fraction | Thickness |
| Sublayer | pores | fraction Ni | ceramic phase | (microns) |
| 1 | 10 | 5 | 85 of Ce_{0.8}Sm_{0.2}O₂ | 7 |
| 2 | 30 | 15 | 55 of Ce_{0.8}Sm_{0.2}O₂ | 7 |
| 3 | 40 | 30 | 30 of Ce_{0.8}Sm_{0.2}O₂ | 10 |
| 4 | 50 | 40 | 10 Ce_{0.8}Sm_{0.2}O₂ | 10 |

It should be noted that some of these sublayers can be combined into fewer sublayers resulting in steeper gradients. For example, sublayers 1 and 2 may be replaced with a single lower sublayer having the average value of porosity and nickel volume fraction of sublayers 1 and 2. Sublayers 3 and 4 may be replaced with a single upper sublayer having the average value of porosity and nickel volume fraction of sublayers 3 and 4.

In another embodiment, indirect microwave heating may be used instead of or in addition to direct microwave heating of the electrode paste to sinter the electrode paste. In this embodiment, the electrode paste coated electrolyte is placed in thermal contact with a microwave absorbing material. Any microwave absorbing material which is heated when irradiated with microwave radiation may be used. For example, the electrolyte may be placed in thermal contact with a susceptor, such as a graphite or other microwave absorbing material susceptor, in a microwave irradiation chamber (i.e., the microwave sintering furnace). The electrolyte may be placed directly on the susceptor or a thermally conductive material may be located between the susceptor and electrolyte. The microwave absorbing material, such as the susceptor, is then irradiated with microwave radiation. The microwave radiation may also be provided onto the electrode paste located on the electrolyte. The microwave radiation heats the microwave absorbing material such that heat from the microwave absorbing material is provided to the electrolyte and to the electrode paste to sinter and debind the electrode.

In another embodiment, microwave radiation is used to sinter the electrolyte. In this embodiment, a SOFC electrolyte precursor material is provided onto a substrate. The precursor material may comprise a green ceramic material, such as a stabilized zirconia, for example yttria or scandia stabilized zirconia green ceramic material. The green ceramic may be formed by tape casting, screen printing, spin coating, roll compaction, uniaxial or isostatic pressing or other ceramic formation methods with or without organic adhesive or binders. The substrate may comprise any suitable supporting material, such as a metal or ceramic substrate.

The green ceramic is then provided into the microwave irradiation chamber (i.e., the sintering furnace). The green ceramic may be provided onto a support, such as a susceptor, stage or other sample holding element in the microwave irradiation chamber with or without the substrate on which the green ceramic was originally formed. Then, the green ceramic and/or the support is irradiated with microwave radiation to sinter the electrolyte. In direct microwave heating, the electrolyte is irradiated with microwave radiation. In indirect microwave heating, the support is irradiated with microwave radiation. If desired, both the green ceramic and the support may be irradiated with microwave radiation.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. A method for debinding and sintering a solid oxide fuel cell (SOFC) electrode, comprising:
depositing a first paste comprising a binder material and a first electrode precursor material onto a first side of a ceramic SOFC electrolyte; and
irradiating the first paste with microwave radiation to sinter and debind the first electrode.

2. The method of claim 1, wherein the frequency of a microwave radiation is between about 0.3 GHz and about 300 GHz.

3. The method of claim 2, further comprising adjusting the frequency of the microwave radiation for maximum microwave absorption by the first paste.

4. The method of claim 1, wherein the first paste is deposited via screen printing or ink jet printing.

5. The method of claim 1, wherein the electrode comprises a SOFC cathode comprising a perovskite material.

6. The method of claim 1, wherein the electrode comprises a SOFC anode electrode comprising a nickel containing phase and a ceramic phase.

7. The method of claim 1, further comprising depositing a second paste comprising a binder material and a second electrode precursor material onto a second side of the ceramic SOFC electrolyte.

8. The method of claim 7, wherein:
the first electrode comprises an anode electrode;
the second electrode comprises a cathode electrode; and
the step of irradiating the first paste with microwave radiation includes irradiating the second paste to sinter and debind the second electrode.

9. The method of claim 8, wherein the microwave radiation comprises a first frequency microwave radiation and a second frequency microwave radiation.

10. The method of claim 9, wherein:
the first frequency is selected for maximum microwave absorption by the first paste; and
the second frequency is selected for maximum microwave absorption by the second paste.

11. The method of claim 9, wherein the first frequency microwave radiation and the second frequency microwave radiation are provided at the same time.

12. The method of claim 9, wherein the first frequency microwave radiation and the second frequency microwave radiation are provided sequentially.

13. The method of claim 9, wherein the first frequency microwave radiation and the second frequency microwave radiation are emitted by separate microwave sources.

14. The method of claim 9, wherein the first frequency microwave radiation and the second frequency microwave radiation are emitted by a multi-mode microwave source.

15. A solid oxide fuel cell (SOFC) electrode formed by the method of claim 1.

16. A method for debinding and sintering a solid oxide fuel cell (SOFC) electrode, comprising:
depositing a first paste comprising a binder material and a first electrode precursor material onto a first side of a ceramic SOFC electrolyte;
placing the electrolyte in thermal contact with a microwave absorbing material; and
irradiating the microwave absorbing material with microwave radiation to heat the microwave absorbing material such that heat from the microwave absorbing material is provided to the electrolyte and to the first paste to sinter and debind the first electrode.

17. The method of claim 16, wherein the microwave absorbing material comprises a graphite susceptor.

18. A method for sintering a solid oxide fuel cell (SOFC) electrolyte, comprising:
providing a SOFC electrolyte precursor material onto a support; and
irradiating at least one of the SOFC electrolyte precursor material or the support with microwave radiation to sinter the electrolyte.

19. The method of claim 18, wherein the SOFC electrolyte precursor material comprises a green ceramic material.

20. The method of claim 18, wherein the step of irradiating at least one of the SOFC electrolyte precursor material or the support comprises irradiating the SOFC electrolyte precursor material.

21. The method of claim 18, wherein the step of irradiating at least one of the SOFC electrolyte precursor material or the support comprises irradiating the support to heat the support such that heat from the support is provided to the electrolyte precursor material to sinter the electrolyte.

22. The method of claim 18, wherein the step of irradiating at least one of the SOFC electrolyte precursor material or the support comprises irradiating both the SOFC electrolyte precursor material and the support.
